(19) United States
(12) Patent Application Publication
(10) Pub. No.: US 2022/0226074 A1
(43) Pub. Date: Jul. 21, 2022

(54) System for body alignment through correction of malocclusions

(71) Applicant: Dang Ha, Odessa, FL (US)

(72) Inventor: Dang Ha, Odessa, FL (US)

(21) Appl. No.: 17/648,187

(22) Filed: Jan. 18, 2022

Related U.S. Application Data
(63) Continuation-in-part of application No. 63/138,897, filed on Jan. 19, 2021.

(51) Int. Cl. A61C 7/00; B33Y 50/00; B33Y 80/00

(52) U.S. Cl. CPC A61C 7/002; B33Y 80/00; B33Y 50/00; A61C 7/006

(57) ABSTRACT

The system for body alignment through tooth position addresses the lack of non-surgical treatment for head, neck, shoulder, and back pain by combining software that generates custom alignment protocols for each patient with a clear aligner embedded with powerful permanent magnets to pull teeth into the desired positions.

### CROSS-REFERENCE TO RELATED APPLICATION

This application is a continuation-in-part of U.S. Pat. App. Ser. No. 63/138,897 filed Jan. 19, 2021, titled System for body alignment through correction of malocclusions.

### FIELD

This invention relates to the field of body alignment and more particularly to a system and device for alignment of the body through correction of malocclusions.

### BACKGROUND

The prevalence of pain medications, particularly opioids, is a source of public health and safety concern. Additionally, opioids are ill-suited for the treatment of long-term pain, and thus are not suitable for many patients.

Alternative, non-pharmaceutical means of treating pain are critical to addressing this issue.

For many patients, pain is caused by misalignment of the back, spine, and head. The source of this misalignment may be malocclusions—the misalignment of the upper and lower plates in the mouth. This condition affects an estimated twenty-eight percent of the US population.

A malocclusion can cause misalignment of the head with the spine. The misalignment of the head with respect to the spine results in pain in the neck, back, and shoulders.

Commonly, such pain is treated with pain medications.

But orthodontic tools that realign the head and spine via realignment of the upper and lower plates in the mouth are an alternative to medication.

As background, the positions of a patient's teeth are classified as one of the following:
Class I—optimum tooth placement
Class II—upper jaw larger than lower—overbite
Class III—upper jaw smaller than lower jaw—underbite

With the goal of moving teeth toward Class I, there exist two primary options for orthodontic treatment: a conventional straight wire technique that uses metal brackets and archwires; and Invisalign, in which a progressive series of plastic trays is fabricated to gradually move teeth from their original position to an aligned position.

Both systems have significant drawbacks.

Regarding conventional brackets and wires: although this system possesses the corrective force needed to correct dental and skeletal malocclusion, patients are deterred by the aesthetic concern combined with the difficulty of maintaining oral hygiene during the course of treatment. Additionally, straight wires and archwires are limited in function, and cannot apply rotational forces or certain angular forces.

Regarding Invisalign: patients find the clear trays to be a lesser aesthetic concern, but Invisalign lacks many of the crucial orthodontic mechanics necessary to correct dental and skeletal malocclusion. Thus, a full course of Invisalign may not complete a patient's orthodontic treatment.

Additionally, the known treatments only focus on the alignment of the teeth toward a Class I placement. The treatments fail to take into account the relationship between the upper jaw, lower jaw, head, and body, and the balance between the head and cervical spine.

What is needed is a system and device to provide non-surgical orthodontic treatment that also treats head, neck, shoulder, and back pain without the use of pain medications.

### SUMMARY

The system for body alignment through tooth position addresses the lack of non-surgical treatments for head, neck, shoulder, and back pain by combining software that generates custom alignment protocols for each patient with a clear aligner embedded with powerful magnets, such as neodymium magnets, to push, pull, rotate, or twist teeth into the desired positions. The goal is to correct tooth position, which in turn corrects jaw position and head position, ultimately correcting posture.

Posture refers to the orientation of the human body, including positions of the head, upper body, lower body, arms, and legs. Postural body stability is the sustaining of the body in equilibrium by maintaining the center of mass within the limits of the base of support, which is generally the feet.

The control of posture is complex. The central nervous system combines multiple inputs to determine how to move and balance the various parts of the body to main stability. Research shows that the central nervous system includes the head and neck position as inputs, as well as the stomatognathic system. The stomatognathic system includes: the joints connecting the jawbone to the skull; the bones forming the oral cavity; soft tissue including tongue and lips; the muscles involved in chewing and swallowing; and the teeth.

Misalignment of sections of the stomatognathic system affects the jaw muscles, affecting jaw position, in turn affecting positions of the head, neck, and cervical spine. For example, studies have shown that subjects with dysfunction of the joint between the jaw and skull have corresponding alterations in head and body posture as compared to normal subjects.

Posture is maintained by the muscles acting in concert. When standing, the muscles ideally cause the spinal column to form an S-shaped curve, with the skull set on a horizontal plane.

But if the head is tilted forward, bending forces are produced all along the length of the spine. The shoulders rotate forward and inward. The pelvis rotates down to push the abdomen forward under the head, and the chest sinks down.

The resulting forward head position increase muscle tension, resulting in strain on the joints within the spine.

To restate, the position of teeth affects the head position, causing head motion front to back, or side to side. This in turn affects body position. The result of this compensation can cause shoulder motion, head motion, rib motion, and hip motion.

The system for body alignment through tooth position seeks to address the alignment and posture of the body by correction of tooth position.

To perform this correction, there are two primary problems that must be addressed.

First, existing software used to estimate final positioning for tooth relocation only accounts for oral considerations, such as Class I occlusion, but cannot account for alignment of the head, jaw, and neck. The disclosed software includes the goal of body alignment when determining desired final tooth positioning.

Second, devices to correct tooth position are either undesirable in appearance or limited in their ability to correct tooth position.

The system for body alignment through tooth position uses magnets in combination with custom aligners to create the forces provided by archwires with the aesthetic benefits of Invisalign.

Turning to the software, first a computed tomography cone beam (CTCB) image of the head is taken, with a full digital scan of upper and lower arch.

A CTCB scanner is a device that uses X-rays to image a skull of a patient, including their teeth. The device outputs a computer file that includes data representing a panoramic, three-dimensional X-ray of the patient's head, including skull, sinuses, and facial nerves.

The resulting computer file, or 3D scan, is uploaded into a computer on which the software executing the system is running. The software then calculates correction of any improperly positioned teeth—malocclusions—in a manner that also corrects the Relative Center of Gravity Zone (RCGZ).

Optionally, the entire body is also scanned, thus allowing the software to take into account the position of all parts of the body when determining the ideal malocclusion correction.

The software compares the tooth positions determined using the scans of the upper arch and lower arch against a database of ideal tooth positions. A list of malocclusions is generated to create a list of incorrect tooth positions.

The system also compares the scan of the entire body against an ideal body position, or posture, to determine what posture issues exist.

By correlating the incorrect tooth positions and the incorrect body positions with a database of associations of malocclusions and posture problems, the system can determine which malocclusion can be corrected to result in associated posture corrections. Additionally or alternatively, the system can use the calculation of the center of gravity of the head to determine which malocclusions are most appropriately corrected first. Restated, the correction of malocclusions that move the head position to a location directly over the spine generally cause correction of posture issues, the posture issues caused by compensation for head position that is ahead of or behind the spine.

Thus, while a database of association between malocclusions and posture problems is helpful, the system does not require it. Instead the system can use the center of gravity of the head as a basis for determining which malocclusions are best treated first.

When calculating the desired tooth position, the software includes the goals of realignment of the jaw, head, and neck. The software further seeks to address occlusal schemes and the mandibular condylar relationship to achieve optimum balance of the head and neck complexes, where “complexes” are the head and neck generally. The term “complexes” is appropriate because all joints, all bones, and muscles from small to large, work together to perform each particular body movement—even an action as simple as balancing one's head on its fulcrum.

The software creates a 3-dimensional model showing the ideal final positions of the teeth, neck, and head to achieve the balance needed to address patient pain. This allows the user, such as an orthodontist, to understand the software's calculations and make adjustments if needed.

After the software has determined the proper tooth alignment to maximize the center of gravity of the head, the appliances are fabricated.

Turning to the appliances, the devices can generate higher and more varied corrective forces than existing products, such as Invisalign. The disclosed devices also provide the first treatment for pain related to malocclusion that does not require surgery or medication. The result is correction of:
misalignment of head and shoulder complex, including unilateral straining of neck and shoulder muscles;
headache due to overload of mastication muscles; and
spinal curvature due to misalignment of head, which in turn causes spinal curvature to compensate for abnormal forces.

Unlike conventional orthodontic appliances, the appliances of the system for body alignment through tooth position are designed to move teeth specifically to a position that was predetermined by the software. The appliances are preferably 3D printed.

The appliances include one or more slots, or other means of holding or affixing, for positioning of small coated permanent magnets, including rare-earth magnets. These magnets are the main engine to drive movement of the teeth.

The user, such as an orthodontist, is able to perform 3D printing of dental plates in house, enabling efficient production of the devices needed to move the teeth.

This approach results in an effective design that is both highly functional and aesthetically pleasing for patients.

The proposed neodymium magnets are already in use in dentistry for retention of dentures, retainers for post orthodontic treatment, and therefore been demonstrated as safe.

For some patients, alignment of the teeth will either be insufficient to address body misalignment, or additional guidance will be needed to address the patient's habits.

These lower body misalignments can be corrected using 3D printed appliances or orthotics.

The fabrication/manufacturing process of the body appliances is similar to the process disclosed above, with a body scan taken and input into software, the software determines the best relative posture. The output of the system is the files required to 3D print the appliances, for example a file in STL format. Printing methodologies used by 3D printers include fused deposition modeling (FDM), powder bed fusion (PDF), and stereolithography (SLA).

Posture correction is best performed in combination with correction of the mandible and tooth positions.

This series of body appliances would be worn by the patient under their normal clothes while working or engaging in normal daily activities. The appliances would allow and facilitate correct postures throughout the day.

Over time, the patient's body will develop muscles tone and strength to be able to have correct posture all the time.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a first view of a skull, showing a Class II alignment.

FIG. 2 illustrates a second view of a skull, showing an alignment correction.

FIG. 3 illustrates an example of a ball balancing, as an analogy for skull balancing.

FIG. 4 illustrates a third view of a skull, including a representation of a spine.

FIG. 5 illustrates a body brace system constructed according to the invention.

FIGS. 6A, 6B, and 6C illustrate the position associations between malocclusions and body posture.

FIG. 7 illustrates a sample set of teeth and a dental appliance to correct tooth position.

FIG. 8 illustrates the steps performed by the software of the body brace system to determine the appliance shapes.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

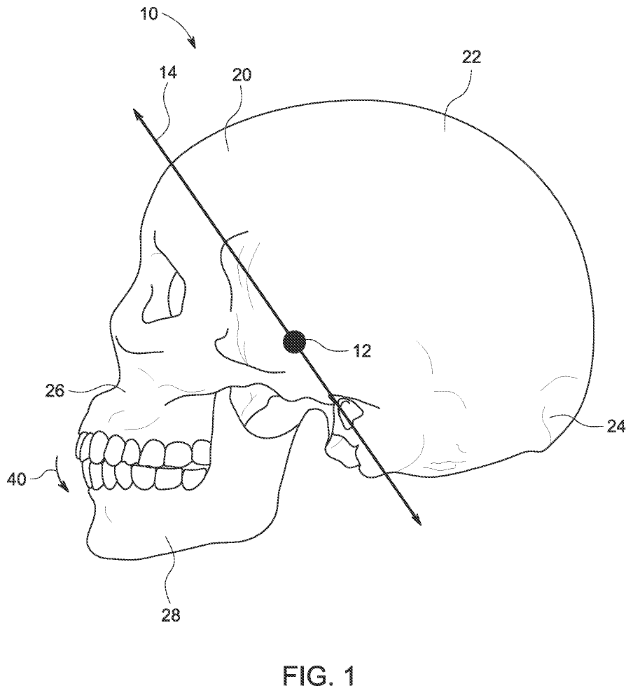

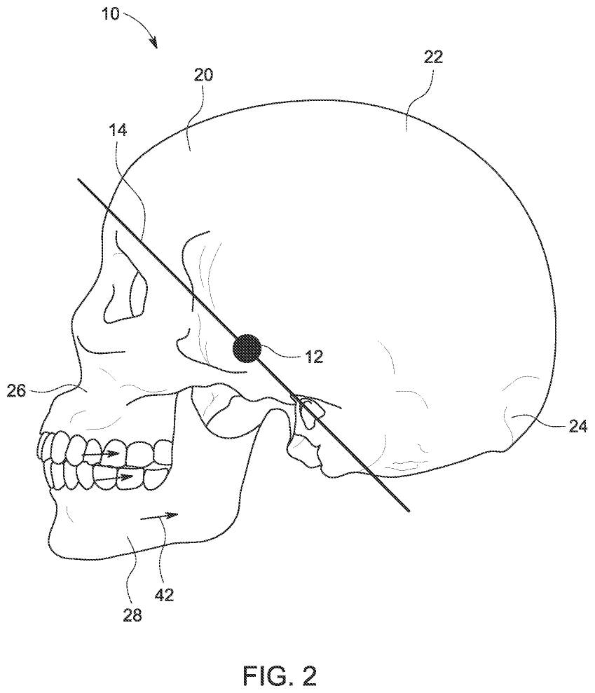

Referring to FIGS. 1 and 2, first and second views of a skull, are shown.

The skull 10 is shown with a CG of skull/articulation point 12 located along the demarcation of break between front and rear of skull 14.

The bones of the rear of the skull 10 include the frontal bone 20, parietal bone 22, and occipital bone 24.

The bones in the front of the skull 10 include the maxilla bone 26 and mandible bone 28. Also shown are teeth 30.

FIG. 1 shows a downward weighting of head 40 caused by the too-forward position of the mandible bone 28. The result is rotation about the CG of skull/articulation point 12, creating an imbalance that the body seeks to correct, thus causing posture issues.

It is apparent that the Class II rotation of the head, forward and downward, can cause significant fatigue pain to muscle group that opposes the forward/downward motion. This imbalance is corrected by adjusting the weight and spatial orientation of the maxilla/mandibular complex via orthodontic movement. As one can balance a perfect sphere on a stick more easily than balancing an irregularly-shaped object, one can appreciate the goal of balancing the head by correcting the position of the center of gravity.

FIG. 2 shows a rearward movement of teeth and jaw 42, moving the mandible bone 28 into the correct position to correct the imbalance.

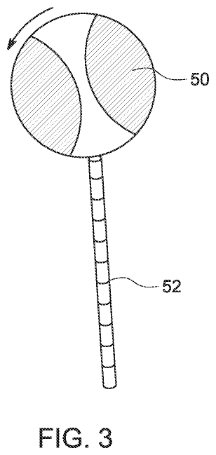

Referring to FIG. 3, an example of a ball balancing as an analogy for skull balancing is shown.

A head balances on the spine just as the ball 50 balances on the stick 52. When the ball 50 is too far to one side—the left in the figure—it will result in rotation, and an imbalance.

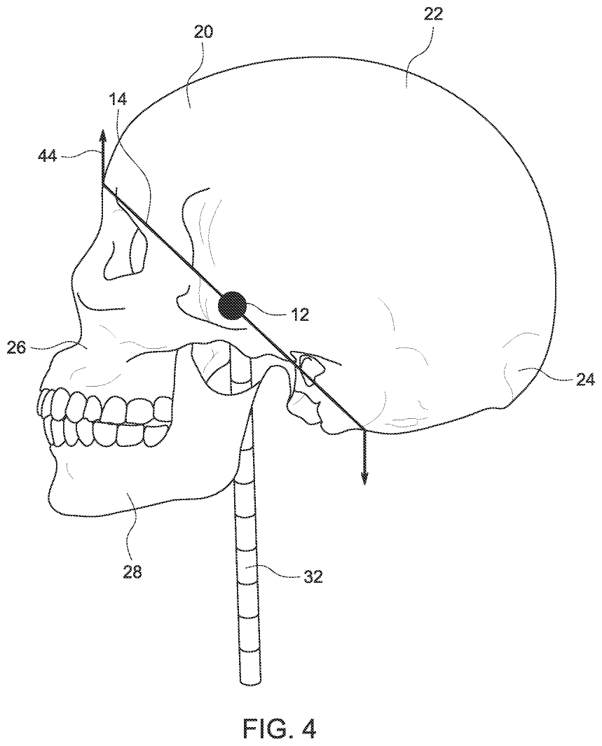

Referring to FIG. 4, a third view of a skull, including a representation of a spine.

The skull 10 is again shown, but now the mandible bone 28 is correctly positioned, creating a rotation to reflect corrected CG 44 directly over spine 32. The result is a balanced skull 10, and thus a balanced user.

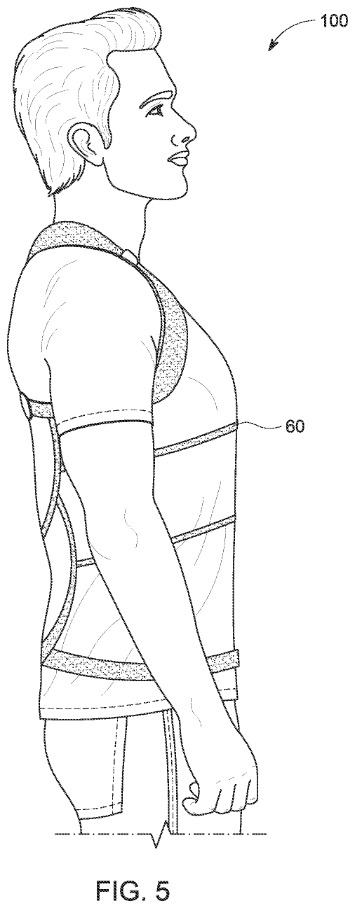

Referring to FIG. 5, a body brace system constructed according to the invention is shown.

The user 100 is shown with a body appliance 60.

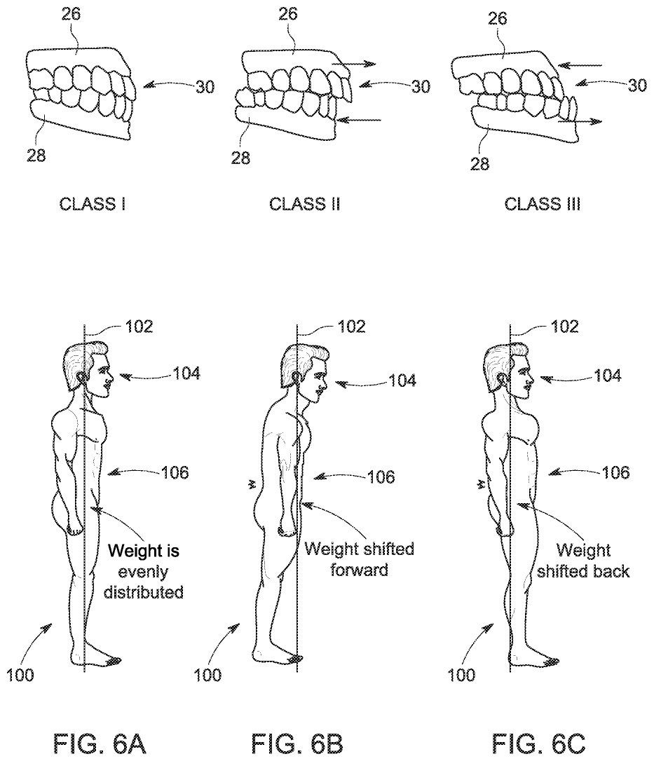

Referring to FIGS. 6A, 6B, and 6C, the position associations between malocclusions and body posture are shown.

Representation of a jaw is shown at the top of each figure formed from teeth 30, maxilla bone 26, and mandible bone 28.

Three types of jaw position are shown, from left to right being Class 1, Class 2, and Class 3. As discussed above, Class I is optimum tooth placement, Class II exists when the upper jaw larger than lower jaw, creating an overbite, and Class III exists when the upper jaw smaller than lower jaw, creating an underbite.

The user 100 is shown balanced about the center of gravity of user 100, with head 104 and body 106.

Class I jaw position is most likely to result in an ideal posture.

Class II jaw position shifts the head forward causing the body to move backward creating a slouched or leaning over posture

Class III jaw position shift the head rearward pushing the body forward creating a tilted back position.

By correcting the body position, moving toward a Class I jaw position, the posture of the user 100 is correspondingly corrected.

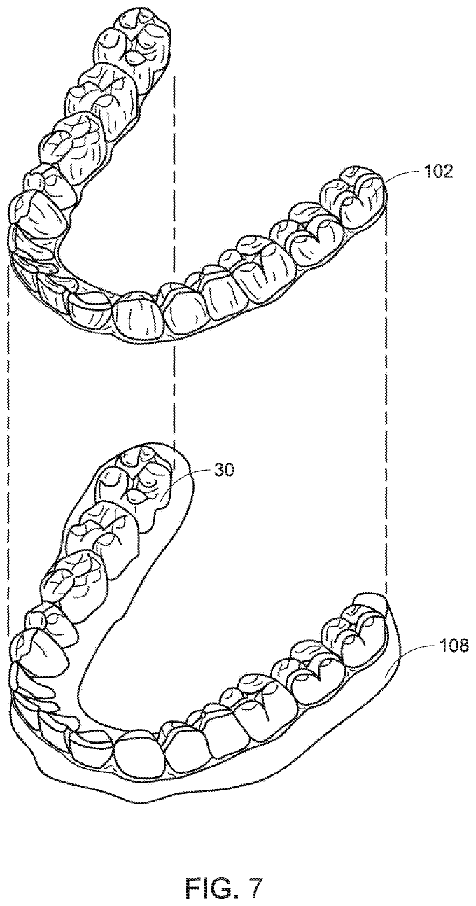

Referring to FIG. 7, a sample set of teeth and a dental appliance to correct tooth position, are shown.

Dental appliance 102 is shown adapted to correct the position of teeth 30 within jaw 1o8.

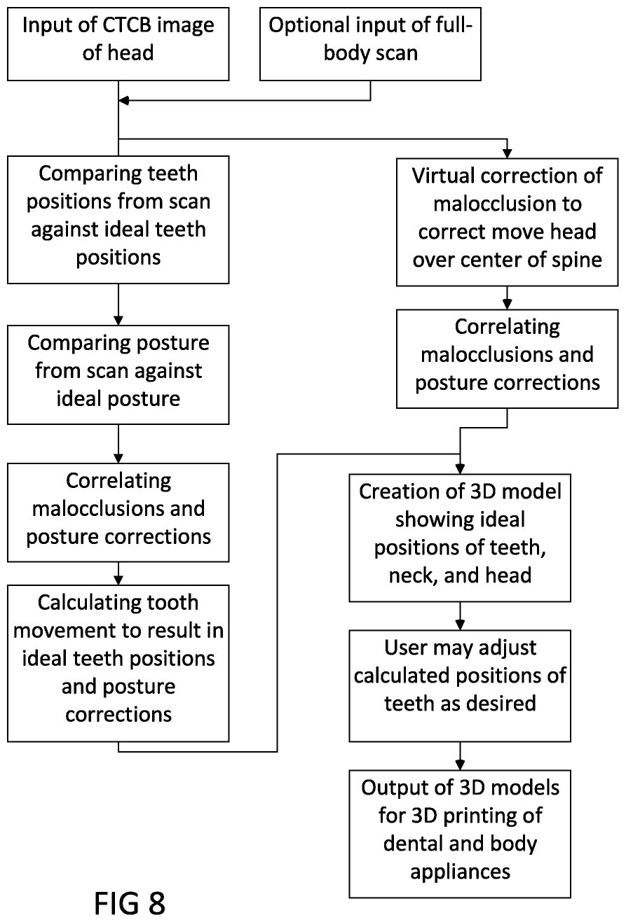

Referring to FIG. 8, the steps performed by the software of the body brace system to determine the appliance shapes are shown.

Two paths are shown: the left path compares the scans against an ideal set of tooth and posture positions; the right path does not require a database of ideal positions, but instead focuses on centering the weight of the head over the spine.

The steps include:
Input of CTCB image of head;
Optional input of full-body scan;
Right path:
   Comparing teeth positions from scan against ideal teeth positions;
   Comparing posture from scan against ideal posture;
   Correlating malocclusions and posture corrections;
   Calculating tooth movement to result in ideal teeth positions and posture corrections;
   Creation of 3D model showing ideal positions of teeth, neck, and head;
   Adjustment by user of calculated positions of teeth; and
   Output of 3D models for 3D printing of appliances.
Right path:
   Virtual correction of malocclusion to correct RCGZ;
   Creation of 3D model showing ideal positions of teeth, neck, and head;
   Adjustment by user of calculated positions of teeth; and
   Output of 3D models for 3D printing of appliances.

The body appliance 60 is preferably 3D printed. The body appliance 60 acts to encourage the user 100 to maintain an appropriate body position by its positioning against pressure points, guiding and supporting a desired posture. Specifically, a posture that causes the major joints to stack perpendicular to the floor.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction, and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A method of correcting body posture of a patient by correcting tooth position comprising the steps of:
obtaining a scan of a human body using a 3D scanner, the human body having an actual posture and actual teeth positions;
comparing the actual teeth positions from the scan of the human body against ideal teeth positions;
referencing a database to determine whether differences between the actual teeth positions and the ideal teeth positions indicate malocclusions;
comparing the actual posture against an ideal posture;
referencing a database to determine whether differences between the actual posture and the ideal posture indicate posture problems;
calculating tooth movement required to move actual teeth positions toward the ideal teeth positions;
calculating shapes of one or more dental appliances that when worn by the patient will cause movement of the actual teeth positions toward the ideal teeth positions; and
outputting files for creation of the one or more dental appliances to be worn by the patient.

2. The method of correcting body posture by correcting tooth position of claim 1, further comprising the step of:
printing the one or more dental appliances using a 3D printer.

3. The method of correcting body posture by correcting tooth position of claim 1, further comprising the steps of:
preparing a graphical representation of suggested tooth position changes to allow a user to prioritize and adjust an order in which malocclusions will be corrected.

4. The method of correcting body posture by correcting tooth position of claim 1, further comprising the steps of:
comparing the malocclusions against a treatment database, the treatment database including an order in which malocclusions should be addressed; and
prioritizing malocclusion treatment based on the treatment database.

5. The method of correcting body posture by correcting tooth position of claim 2, wherein:
the one or more dental appliances include integrated permanent magnets;
the integrated permanent magnets helping to move actual teeth positions toward ideal teeth positions.

6. The method of correcting body posture by correcting tooth position of claim 1, further comprising the steps of:
preparing 3D models of body orthotics to position a user to move the actual posture and toward the ideal posture.

7. The method of correcting body posture by correcting tooth position of claim 6, further comprising the steps of:
printing one or more body orthotics, represented by the 3D models of body orthotics, using a 3D printer.

8. A method for correcting a posture of a patient caused by improper tooth position, the method comprising the steps of:
receiving a mouth scan of the patient that includes positions of teeth of the patient;
receiving a head scan that includes a position of a head of the patient with respect to a spine of the patient;
calculating a center of gravity of the head;
determining whether the center of gravity of the head is over the spine;
receiving a body scan of that includes posture data, the posture data including positions of the patient's: upper body, lower body, arms, and legs;
processing the mouth scan and creating a malocclusion list;
determining which malocclusions of the malocclusion list, when corrected, would help to move the center of gravity of the head to a position directly over the spine, whereby correction of the malocclusions that would move the center of gravity of the head to a position over the spine is prioritized;
processing the body scan and creating a posture abnormality list;
determining whether there are any correlations between the malocclusion list and the posture abnormality list, such that correction of malocclusion would result in a posture correction;
outputting a correlation list for review by a user, the user able to rank order the malocclusions to create a rank-ordered correlation list for correction;
determining which tooth positions need to be altered in order to correct the malocclusions, and correspondingly correct posture abnormalities from the posture abnormality list;
calculating one or more shapes for one or more dental appliances required to correct malocclusions based on the rank-ordered correlation list generated by the user;
outputting 3D model files to allow the user to manufacture the one or more dental appliances required.

9. The method for correcting a posture of a patient caused by improper tooth position of claim 8, further comprising the step of:
printing one or more dental appliances represented by the 3D model files using a 3D printer.

10. The method for correcting a posture of a patient caused by improper tooth position of claim 8, further comprising the steps of:
preparing a graphical representation of suggested tooth position changes to allow a user to prioritize and adjust the changes.

11. The method for correcting a posture of a patient caused by improper tooth position of claim 8, further comprising the steps of:
comparing one or more malocclusions from the malocclusion list against a treatment database, the treatment database including an order in which malocclusions should be addressed;
prioritizing malocclusion treatment based on the treatment database;

12. The method for correcting a posture of a patient caused by improper tooth position of claim 8, further comprising the steps of:
preparing 3D models of body orthotics to help correct the posture of the user by moving the patient's: upper body, lower body, arms, and legs into their correct locations.

13. The method for correcting a posture of a patient caused by improper tooth position of claim 12, further comprising the steps of:
printing one or more body orthotics, represented 3D models of body orthotics, using a 3D printer.

14. A method of correcting posture of a user by correction of teeth and skull bone positions within a head of a user, the method comprising:
performing a scan to measure positions of the teeth and skull bones of a user, creating a scan file;
calculating a center-of-gravity of the user's head based upon the scan file and known tooth and bone weights;
outputting a set of desired tooth and bone positions to correct the center-of-gravity of the head to an ideal, balanced position;
outputting files for 3D printing of appliances for placement over the teeth, progressively causing tooth movement;
whereby completion of movement of the teeth, corrects location of the center-of-gravity and thus the posture.

15. The method of correcting posture of a user by correction of teeth and skull bone positions within a head of a user of claim 14, further comprising:
outputting files for 3D printing of body appliances for correction of a user's body posture by application of pressure to specific points on a user's body.

16. The method of correcting posture of a user by correction of teeth and skull bone positions within a head of a user of claim 14, further comprising the step of:
printing the appliances for placement over the teeth using a 3D printer.

17. The method of correcting posture of a user by correction of teeth and skull bone positions within a head of a user of claim 15, further comprising the step of:
printing the body appliances, represented by the files for 3D printing of body appliances, using a 3D printer.
